(19) United States
(12) Patent Application Publication
(10) Pub. No.: US 2007/0218839 A1
(43) Pub. Date: Sep. 20, 2007

(54) Control loop

(75) Inventor: Ralf Huck, Grosskrotzenburg (DE)

Correspondence Address: BUCHANAN, INGERSOLL & ROONEY PC, POST OFFICE BOX 1404, ALEXANDRIA, VA, 22313-1404, US

(73) Assignee: ABB Patent GmbH, Ladenburg (DE)

(21) Appl. No.: 11/717,701

(22) Filed: Mar. 14, 2007

(30) Foreign Application Priority Data
Mar. 14, 2006 (DE) 10 2006 011 607.0

(51) Int. Cl. H04B 1/00; H04B 15/00

(52) U.S. Cl. 455/63.1; 455/68

(57) ABSTRACT

The invention relates to a control loop comprising a measured-value sensor (200), a control device (300) and an actuator (400), the actuator being connected to the measured-value sensor (200) via the industrial process (100). To detect faults in the control loop, it is proposed to impress on the wanted signal an interference signal having definable signal parameters, which is injected into the control loop by an interference-signal source (51 to 53). The interference-signal source has means for detecting and evaluating the interference signal fed back via the control loop in the direction of control action.

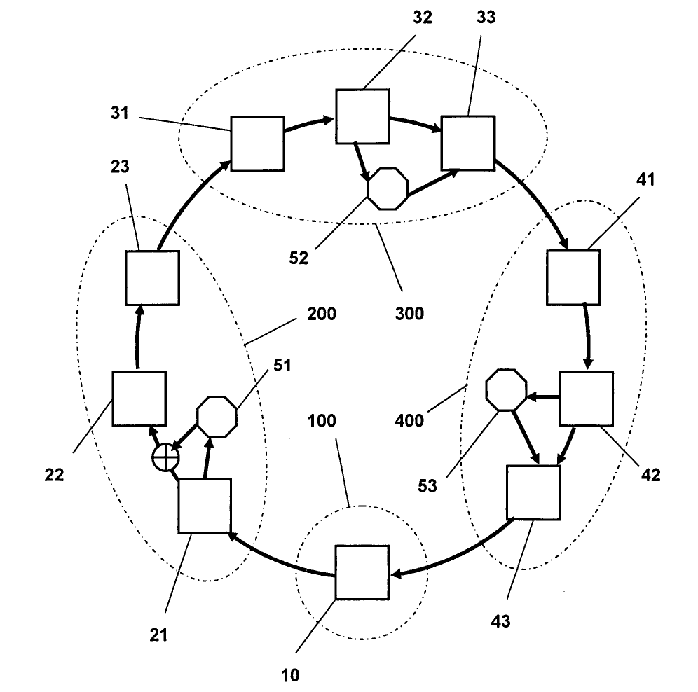

The invention relates to a control loop comprising a plurality of control-loop elements, but comprising at least one measured-value sensor, one control device and one actuator, the actuator being connected to the measured-value sensor via the industrial process.

A control loop normally has a measured-value sensor that is connected to an input of a control device. The control device is equipped with at least one output, to which an actuator is connected. An industrial process, whose parameters are set by the actuator and detected by the measured-value sensor, closes the control loop. The control device outputs to the actuator a control value that depends on the measured value detected by the measured-value sensor. The measured values can be transmitted from the measured-value sensor to the control device, and from the control device to the actuator, in analog or digital form, by wired or wireless communication.

Interruptions in transmission occur as a result of faults, and the interruptions remain undetected.

Thus the object of the invention is to develop a control loop known per se in such a way that faults in the control loop can be detected.

This object is achieved according to the invention by the means of claim 1. Advantageous embodiments of the invention are given in the dependent claims.

The invention is based on a control loop comprising a plurality of control-loop elements. The control loop comprises in the direction of control action a measured-value sensor, a control device, an actuator and a control process, with the wanted signal circulating in the control loop in the direction of control action. Each of the control-loop elements cited can also be composed internally of further control-loop elements.

According to the invention, an interference signal having definable signal parameters is impressed on the wanted signal at an arbitrary point of the control loop, said interference signal being injected into the control loop by an interference-signal source. The interference-signal source also has means for detecting and evaluating the interference signal fed back via the control loop in the direction of control action.

The response of the control loop is monitored as a function of the interference signal. The interference signal here passes through all the control-loop elements and the connecting elements between the control-loop elements of the whole control loop. Faults in the control loop have an effect on the interference signal and its transmission within the control loop. The nature of the fault can be deduced from the form that the effect takes.

Even faults such as broken connecting wires, frozen measured values and/or control values, damaged measured-value sensors and/or actuators, incorrectly connected control-loop elements or combinations of such faults are advantageously detected by this means. Control loops having a slow dynamic response benefit in particular from this advantage.

The characterizing signal parameters of the interference signal, which are essentially defined by the duration, polarity and signal shape, can be defined. The interference signal advantageously does not contain common-mode components and is of short duration in order to avoid interfering with the industrial process.

According to another feature of the invention, the interference-signal source is part of the measured-value sensor. The interference signal here passes through the control loop as an electrical signal as far as the actuator, before passing into the industrial process as a physical signal. The response of the control loop to the interference signal is advantageously available as an electrical signal at any control-loop elements outside the industrial process.

According to an alternative feature of the invention, the interference-signal source is part of the actuator. The interference signal here passes through the control loop initially as a physical signal in the industrial process as far as the measured-value sensor before it is transformed back into an electrical signal.

According to a further alternative feature of the invention, the interference-signal source is part of the control device.

Regardless of where the interference-signal source physically belongs, it can be provided that the interference signal is assigned an expected value of the change in wanted signal. The superimposed signal is circulated in the control loop. After a definable time has elapsed, the change in wanted signal that is actually detected is compared with the expected value of the change in wanted signal. The differences found between the change in wanted signal actually detected and the expected value of the change in wanted signal are signaled as an alert to a higher-level device.

According to a further feature of the invention, the interference signal is superimposed periodically on the wanted signal. This advantageously achieves continuous fault detection for minimum impact on the industrial process.

According to a further feature of the invention, the interference signal is superimposed on the wanted signal on the basis of a given event occurring. This feature permits automatic initiation of a test on the basis of detecting an incorrect response of the control loop.

The invention is described in greater detail below with reference to an exemplary embodiment and the necessary drawings which show:

The single FIGURE shows a block diagram of a control loop having a plurality of control-loop elements 10 to 43, which are grouped into physical units and assigned to an industrial process. The control-loop elements 21 to 23 are parts of a measured-value sensor 200. The control-loop elements 31 to 33 form a control device 300, and the control-loop elements 41 to 43 constitute an actuator 400. The industrial process 100 is represented as a single control-loop element 10 regardless of its complexity.

A predefined interference signal is injected at an arbitrary point of the control loop by conventional means. The response of the control loop as a function of the interference signal is monitored at another point of the control loop that is located in the same higher-level control-loop element 100 to 400 and is separated by at least one control-loop element 10 to 43 from the injection point.

In a first embodiment of the invention, an interference-signal source 51 is provided, whose interference signal is superimposed on the control-loop signal between two consecutive control-loop elements 21 and 22 at a summation point in the measured-value sensor 200. In this case, an electrical interference signal can be coupled in at the summation point by resistive, capacitive or inductive methods known per se. It can be provided here that an interference signal is superimposed on the measurement current of a measured-value sensor 200, which is normally kept at a constant level.

The interference signal is coupled out at another point of the control loop within the measured-value sensor 200, namely at the control-loop element 21, and fed to the interference-signal source 51.

In a second embodiment of the invention, an interference-signal source 52 is provided as part of the control device 300, which injects an interference signal directly into a control-loop element 32. The interference signal is coupled out at another point of the control loop within the control device 300, namely at the control-loop element 31, and fed to the interference-signal source 52.

In a third embodiment of the invention, an interference-signal source 53 is provided as part of the actuator 400, which injects an interference signal directly into a control-loop element 43. The interference signal is coupled out at another point of the control loop within the actuator 400, namely at the control-loop element 42, and fed to the interference-signal source 53.

In each embodiment, the interference signal passes through all the control-loop elements 10 to 43 and the connecting elements between the control-loop elements 10 to 43 of the whole control loop. Faults in the control loop have an effect on the interference signal and its transmission within the control loop. The nature of the fault can be deduced from the form that the effect takes.

In a further embodiment of the invention, an expected value of the change in wanted signal is assigned to the interference signal. The superimposed signal is sent to the control device 300. After a definable time has elapsed, the change in wanted signal that is actually detected is compared with the expected value of the change in wanted signal. The differences found between the change in wanted signal actually detected and the expected value of the change in wanted signal are signaled as an alert to a higher-level device.

In a further embodiment of the invention, the interference signal is superimposed periodically on the wanted signal. This advantageously achieves continuous fault detection in the control system for minimum impact on the industrial process.

In a further embodiment of the invention, the interference signal is superimposed on the wanted signal on the basis of a given event occurring. This feature permits automatic initiation of a test on the basis of detecting an incorrect response of the control loop. It can be provided in this case that the initial event is actuated manually as required. Alternatively, it can be provided that the test of the control loop is initiated by a definable time period elapsing without a change in wanted signal.

### LIST OF REFERENCES

10 to 43 control-loop element
51 to 53 interference-signal source
100 process
200 measured-value sensor
300 control device
400 actuator

1. A control loop comprising in the direction of control action a measured-value sensor, a control device, an actuator and a control process, with the wanted signal circulating in the control loop in the direction of control action,
wherein
an interference signal having definable signal parameters is impressed on the wanted signal, said interference signal being injected into the control loop by an interference-signal source, and
the interference-signal source has means for detecting and evaluating the interference signal fed back via the control loop in the direction of control action.

2. The control loop as claimed in claim 1, wherein the interference-signal source is part of the measured-value sensor.

3. The control loop as claimed in claim 1, wherein the interference-signal source is part of the actuator.

4. The control loop as claimed in claim 1, wherein the interference-signal source is part of the control device.

5. The control loop as claimed in claim 1, wherein each interference signal is assigned an expected value of the change in wanted signal, where on the basis of the change in wanted signal that is actually detected compared with the expected value of the change in wanted signal, the difference can be signaled as an alert to a higher-level device.

6. The control loop as claimed in claim 5, wherein the interference signal is superimposed periodically on the wanted signal.

7. The control loop as claimed in claim 5, wherein the interference signal is superimposed on the wanted signal on the basis of a given event occurring.

8. The control loop as claimed in claim 2, wherein each interference signal is assigned an expected value of the change in wanted signal, where on the basis of the change in wanted signal that is actually detected compared with the expected value of the change in wanted signal, the difference can be signaled as an alert to a higher-level device.

9. The control loop as claimed in claim 3, wherein each interference signal is assigned an expected value of the change in wanted signal, where on the basis of the change in wanted signal that is actually detected compared with the expected value of the change in wanted signal, the difference can be signaled as an alert to a higher-level device.

10. The control loop as claimed in claim 4, wherein each interference signal is assigned an expected value of the change in wanted signal, where on the basis of the change in wanted signal that is actually detected compared with the expected value of the change in wanted signal, the difference can be signaled as an alert to a higher-level device.
